(19) United States
(12) Patent Application Publication
(10) Pub. No.: US 2023/0185674 A1
(43) Pub. Date: Jun. 15, 2023

(54) SYSTEM AND METHOD FOR OPTIMIZED SCHEDULING OF DATA BACKUP/RESTORE

(71) Applicant: Druva Inc., Sunnyvale, CA (US)

(72) Inventors: Stephen Manley, Livermore, CA (US); Preethi Srinivasan, Sunnyvale, CA (US); Ritesh Singh, Jamshedpur (IN); Ajay Potnis, Pune (IN)

(21) Appl. No.: 17/551,593

(22) Filed: Dec. 15, 2021

(51) Int. Cl. G06F 11/14; G06N 20/00

(52) U.S. Cl. CPC G06F 11/1461; G06N 20/00

(57) ABSTRACT

A system to optimize scheduling of a data backup and/or restore of a backup data in a data backup/restore environment is presented. The system includes a training module configured to train an artificial intelligence (AI) model based on historical data corresponding to data backup and/or restore of one or more training datasets. The system further includes a time estimator configured to estimate an estimated time taken for the data backup and/or restore of the backup data to a data backup server or a restore location based on the trained AI model and operating data corresponding to operating states of one or more resources in the data backup/restore environment. A related method is also presented.

### BACKGROUND

Embodiments of the present invention generally relate to systems and methods for data backup and/or restore, and more particularly to systems and methods that enable optimized scheduling of a data backup and/or restore.

Enterprises these days seek reliable, cost-effective ways to protect the data stored on their computer networks while minimizing the impact on productivity. An enterprise might back up critical computing systems such as databases, file servers, web servers, virtual machines, and so on as part of a daily, weekly, or monthly maintenance schedule. In the event of data loss, data corruption, and/or other disaster-related occurrences, the backed-up data may be restored to the primary data source or another restore destination. However, current methods and systems for data backup and/or restore typically do not provide for optimized scheduling of a data backup and/or restore.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system to optimize scheduling of a data backup and/or restore of a backup data in a data backup/restore environment is presented. The system includes a training module configured to train an artificial intelligence (AI) model based on historical data corresponding to data backup and/or restore of one or more training datasets. The system further includes a time estimator configured to estimate an estimated time taken for the data backup and/or restore of the backup data to a data backup server or a restore location based on the trained AI model and operating data corresponding to operating states of one or more resources in the data backup/restore environment.

According to another example embodiment, a system to optimize scheduling of a data backup and/or restore of a backup data in a data backup and/or restore environment is presented. The system includes a memory storing one or more processor-executable routines and a processor communicatively coupled to the memory. The processor is configured to execute the one or more processor-executable routines to train an artificial intelligence (AI) model based on historical data corresponding to data backup and/or restore of one or more training datasets; receive operating data corresponding to operating states of one or more resources in the data backup and/or restore environment; and estimate based on the trained AI model and the operating data an estimated time taken for the data backup and/or restore of the backup data to a data backup server or a restore location.

According to another example embodiment, a method to optimize scheduling of a data backup and/or restore of backup data in a data backup/restore environment is presented. The method includes training an artificial intelligence (AI) model based on historical data corresponding to data backup and/or restore of one or more training datasets. The method further includes receiving operating data corresponding to operating states of one or more resources in the data backup/restore environment. The method furthermore includes estimating, based on the trained AI model and the operating data, an estimated time taken for the data backup and/or restore of the backup data to a data backup server or a restore location.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example data backup/restore system environment, according to some aspects of the present description,

FIG. 2 is a block diagram illustrating an example data backup system environment, according to some aspects of the present description,

FIG. 3 is a block diagram illustrating an example data backup/restore scheduling system, according to some aspects of the present description,

FIG. 4 is a flow chart illustrating a method for estimating a time for data backup/restore, according to some aspects of the present description,

FIG. 5 is a flow chart illustrating a method for scheduling a data backup/restore, according to some aspects of the present description, and

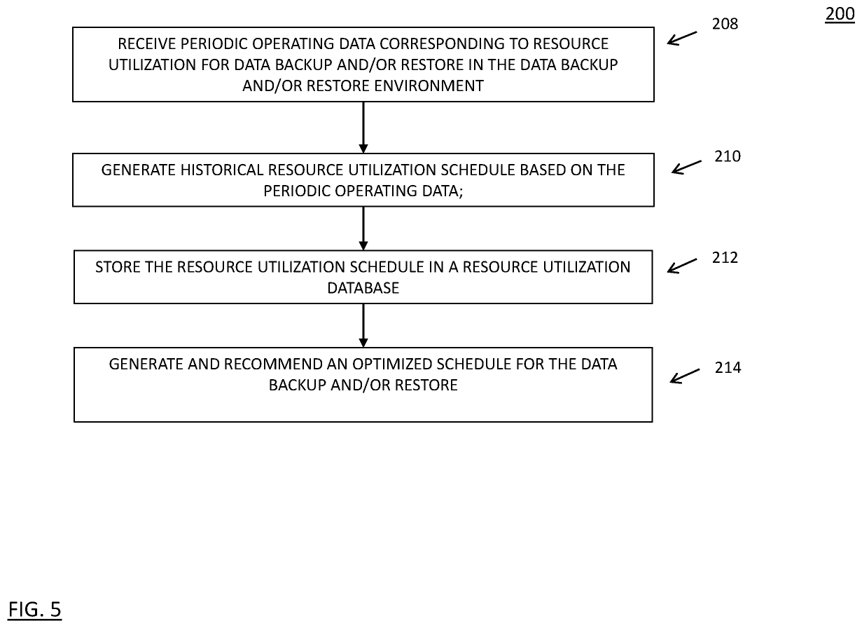

FIG. 6 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide systems and methods for estimating a time for data backup/restore using trained AI models. Some embodiments of the present description provide systems and methods for optimized scheduling of a data backup/restore based on the estimated time.

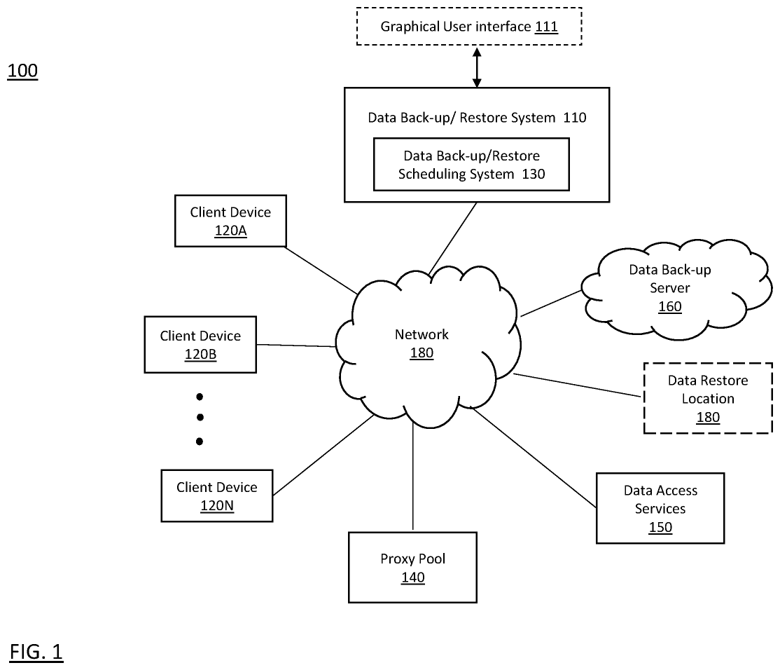

FIG. 1 illustrates an example data backup/restore system environment 100, in accordance with some embodiments of the present description. The data backup/restore system environment 100 includes a data backup/restore system 110, one or more client devices 120 (120A, 120B . . . 120N), a data backup/restore scheduling system 130, a proxy pool 140, data access services 150, data backup server 160, and optionally a restore location 170 (during a data restore scenario). The data backup/restore system environment 100 may be configured to back up data from the one or more client devices 120 in the data backup server 160 using the data backup system 110 and the proxy pool 140. Alternately, the data backup/restore system environment 110 may be configured to restore data from the data backup server 160 to a restore location 170 using the data backup system 110 and the proxy pool 140. Examples of data to be backed up/restored include, but are not limited to, a text file, an image file, an audio clip, a video clip, an email, a data file, or any combination thereof.

The data backup/restore system 110 may be a software or a hardware component that enables the one or more client devices 120 to back up or restore data, and optionally search and access the backup data. In some embodiments, the data backup/restore system 110 is a cloud-based service. As described in detail later, the data backup/restore system 110 further includes a data backup/restore scheduling system 130 configured to estimate a time taken for data backup/restore and/or generate a recommended schedule for the data backup/restore

The data backup/restore system 110 may optionally further provide a graphical user interface 111 for individual clients to control the data backup/restore process. For example, a graphical user interface 111 may be a front-end cloud storage interface. Additionally, or the data backup/restore system 110 may provide APIs for the access and management of files from the data backup server 160.

The one or more client devices 120 (referred to herein as “device”) may be any computing devices that have data that may need backup. Examples of such devices 120 include without limitation, workstations, personal computers, desktop computers, or other types of generally fixed computing systems such as mainframe computers, servers, and minicomputers. Other examples of such devices 120 include mobile or portable computing devices, such as one or more laptops, tablet computers, personal data assistants, mobile phones (such as smartphones), IoT devices, wearable electronic devices such as smartwatches, and other mobile or portable computing devices such as embedded computers, set-top boxes, vehicle-mounted devices, wearable computers, etc. Servers can include mail servers, file servers, database servers, virtual machine servers, and web servers.

In some embodiments, the data backup/restore system environment 100 includes a plurality of devices 120. The plurality of devices 120 may be from a single client or from different clients being serviced by the data backup/restore system 110 such as shown in FIG. 1. In some embodiments, the data backup/restore system environment 100 includes a single device 120 having a plurality of data sets or one large data set that needs to be backed up/restored.

The data backup/restore system environment 100 further includes the proxy pool 140 and cloud access services 150. The proxy pool 140 is a collection of backup/restore proxies. The data backup/restore system 110 is configured to backup/restore data to the data backup server 160 or the restore location 170 by using the proxy pool 140 including a plurality of proxies.

In some embodiments, the data backup server 160 is a cloud-based storage. The data sets from the one or more devices 120 may be stored and backed up in an object-based storage, a file-based storage, or a block-based storage. Non-limiting examples of suitable data backup server 160 include AMAZON S3, RACKSPACE CLOUD FILES, AZURE BLOB STORAGE, and GOOGLE CLOUD STORAGE.

The restore location 170 may be packaged/configured with the client device 120 (e.g., an internal hard disk) and/or may be external and accessible by the client device 120 (e.g., network-attached storage, a storage array, etc.). Non-limiting examples of the restore location 170 may include, without limitation, disk drives, storage arrays (e.g., storage-area network (SAN) and/or network-attached storage (NAS) technology), semiconductor memory (e.g., solid-state storage devices), network-attached storage (NAS) devices, tape libraries, or other magnetic, non-tape storage devices, optical media storage devices, or combinations thereof. In some embodiments, the restore location 170 is provided in a cloud storage environment (e.g., a private cloud or one operated by a third-party vendor). In embodiments where the restore location 170 is a storage system internal to the client device 120, the block representing the restore location 170 may be present in the client device 120 itself.

The various components in the data backup/restore system environment 100 may communicate through the network(s)180 and/or locally. It should be noted that although a single block 180 is shown to represent a network in FIG. 1, the system environment 100 may include a plurality of networks 180 to connect different components of the system environment 100. For example, in some embodiments, one of the system components may communicate locally with the data backup/restore system 110, while other components communicate with the data backup/restore system 110 through the networks. In other embodiments, every component in the data backup/restore system environment 100 is online and communicates with each other through the network(s) 180. In one embodiment, the network(s) 180 use standard communications technologies and/or protocols. Thus, the network(s) 180 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network(s) 180 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc.

While the data backup/restore system 110, the data backup/restore scheduling system 130, the proxy pool 140, the data access services 150, the data backup server 160, and the restore location 170 are each represented by a single block in FIG. 1, each of these components may include multiple distributed and/or independent computers (may also be referred to as workers) working cooperatively and in parallel with other computers so that the operation of the entire system will not be affected when one or more workers are down.

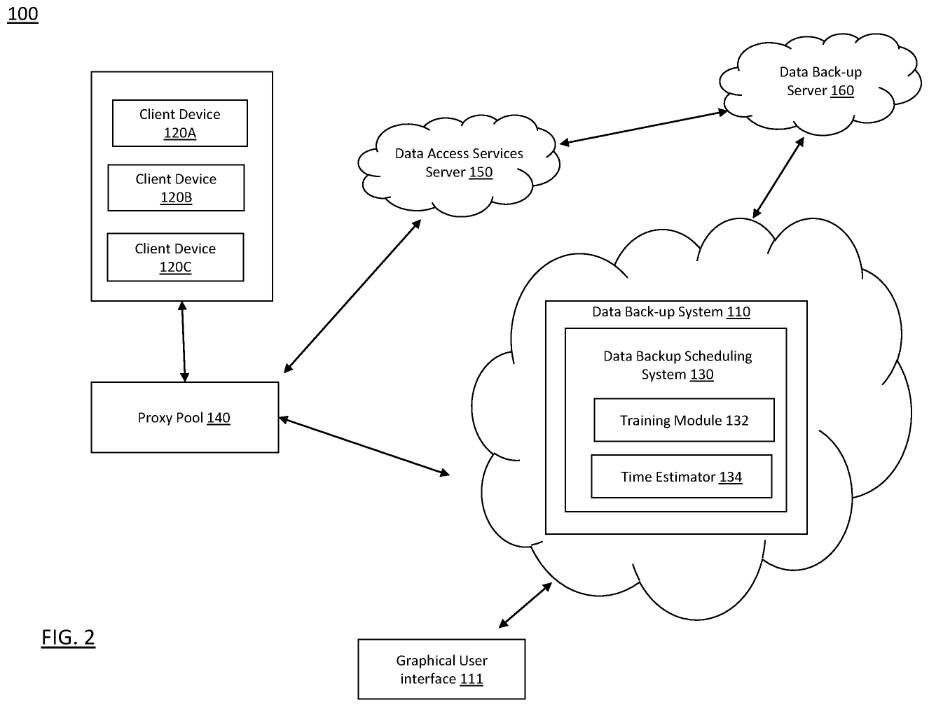

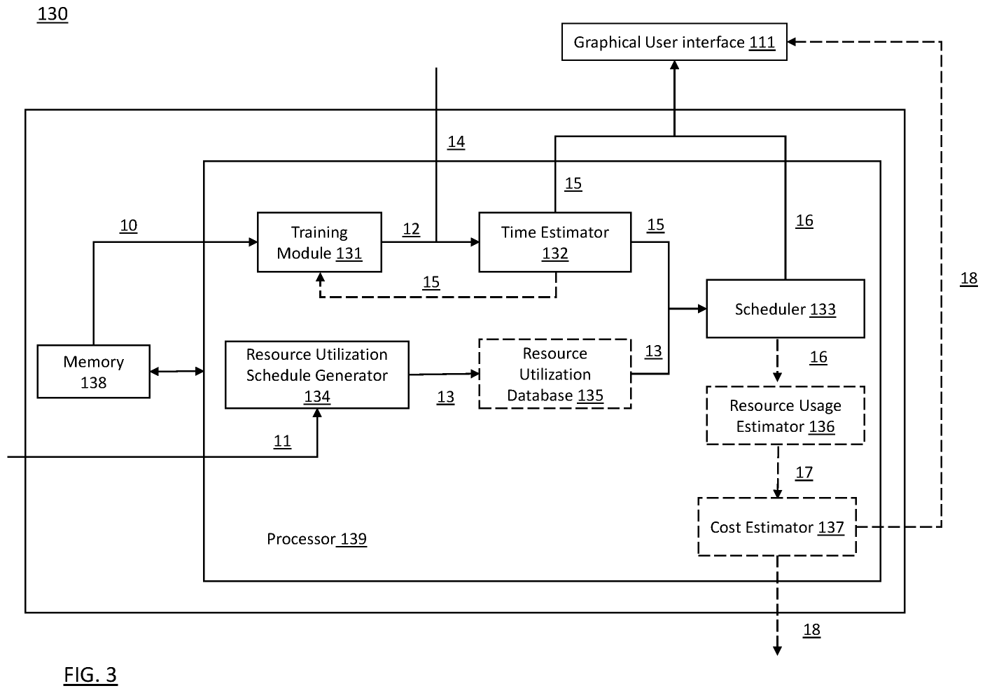

FIG. 2 is a block diagram of an example data backup/restore environment 100 including the data backup/restore system 110, in accordance with some embodiments of the present description. FIG. 2 shows three client devices 120A, 120B, and 120C for illustration purposes only, and as mentioned earlier, the data backup/restore system environment 100 may include any number of devices. The data backup/restore system environment 100 further includes a proxy pool 140, data access services 150, and a cloud-based data backup server 160. As shown in FIG. 2, the data backup/restore system 100 further includes a data backup scheduling system 130 including a training module 131 and a time estimator 132. Each of these components will be described in detail below with reference to FIG. 3.

FIG. 3 is a block diagram of an example data backup/restore scheduling system 130, in accordance with some embodiments of the present description. As shown in FIG. 3, the data backup/restore scheduling system includes a training module 131 and a time estimator 132. The training module 131 is configured to train an artificial intelligence (AI) model based on historical data 10 corresponding to data backup/restore of one or more training datasets. Non-limiting examples of the AI model include time series forecasting models such as an autoregressive integrated moving average (ARIMA) model or a seasonal autoregressive integrated moving average (SARIMA) model.

The one or more training data sets may correspond to data from the same or a different client device as the one being currently backed up/restored. Further, in some instances, the one or more training data sets may correspond to data from a different client. Moreover, the historical data corresponding to the one or more training data sets may correspond to an incremental backup or a full backup. The historical data may be stored in a memory 138 (as shown in FIG. 3) or a cloud-based service (not shown in FIGs.), and may be accessed by the training module 131 to train the AI model.

Non-limiting examples of historical data used to train the AI model include client device parameters, proxy parameters, file system parameters, data backup system parameters, data backup server parameters, network parameters, parallelization parameters, dataset type, dataset size, day of the week, time of the day, and time taken for data backup and/or restore for the training datasets.

Client device parameters may include, for example, CPU, IO bandwidth, network bandwidth, memory device IOs, Device NW throughput, and the like. Proxy parameters may include, for example, number of proxies, proxy CPUs, proxy memory, proxy NW bandwidth, and the like. File system parameters may include, for example, Read FS minimum concurrency, maximum percentage memory, data channel size, and the like. Data backup system parameters may include, for example, internal back up systems' performance on read, write, merge, concurrency, channel size, etc. Data backup server parameters may include, for example, AWS parameters such as instance type, instance size, availability zone, etc.

Network parameters may include, for example, network requests, number of read APIs for each session, number of write APIs for each session, and the like. Parallelization parameters may include, for example, number of parallel backups, number of parallel restores, and the like. The historical data may further include metadata such as type of operation (backup/restore), operation status (success/failure), dataset type, dataset size, day of the week, time of the day, and time taken for data backup and/or restore.

Referring again to FIG. 3, the time estimator 132 is configured to estimate an estimated time 15 taken for the data backup/restore of the backup data based on the trained AI model 12 and operating data 14 corresponding to operating states of one or more resources in the data backup/restore environment 100. The operating data 14 may be generated in real-time and/or based on a pre-defined configuration. For example, the number of proxies may be based on a pre-determined configuration while the network bandwidth may be recorded in real-time. The real-time operating data 14 may be recorded using any suitable techniques, for example, open telemetry.

In some embodiments, the estimated time 15 may be presented as an output to a user via the output module 140, as shown in FIG. 3. The output can be presented to user in multiple ways, such as, for example, GUI, API, integration to event management systems, messaging/alerting systems, ticket management systems, virtualization platforms, etc. In some embodiments, the training module 131 is further configured to periodically or continuously retrain the AI model based on the estimated time 15 and actual time taken for a data backup and/or restore.

The time estimated for data backup/restore may be further used to generate an optimized schedule for data backup/restore in accordance with some embodiments of the present description. As shown in FIG. 3, the data backup/restore scheduling system 130 further includes a scheduler 133 configured to generate and recommend an optimized schedule for the data backup/restore based on the estimated time and a historical resource utilization schedule.

The data backup/restore scheduling system 130 further includes a resource utilization schedule generator 134 configured to generate and store the historical resource utilization schedule 13 based on periodic operating data 11 corresponding to resource utilization for data backup/restore in the data backup/restore environment 100.

As shown in FIG. 3, in some embodiments, the historical resource utilization schedule 13 may be stored in a resource utilization database 134. The scheduler 133 is configured to access the estimated time 12 from the time estimator 132 and the resource utilization schedule 13 from the resource utilization database 134 to generate a recommended schedule 16. In some embodiments, the recommended schedule 16 may be presented as output to a user via the output module 140, as shown in FIG. 3. The recommended schedule may include details such as a recommended date and time for data backup/restore.

The recommended schedule may be further used to estimate a cost for data backup/restore in accordance with some embodiments of the present description. As shown in FIG. 3, the data backup/restore scheduling system 130 further includes a resource usage estimator 136 and a cost estimator 137. The resource usage estimator 136 is configured to estimate a resource usage 17 based on the recommended schedule or a schedule selected by a user for the data backup/restore of the backup data. The cost estimator 137 is configured to estimate a cost 18 for the data backup/restore of the backup data based on the estimated resource usage.

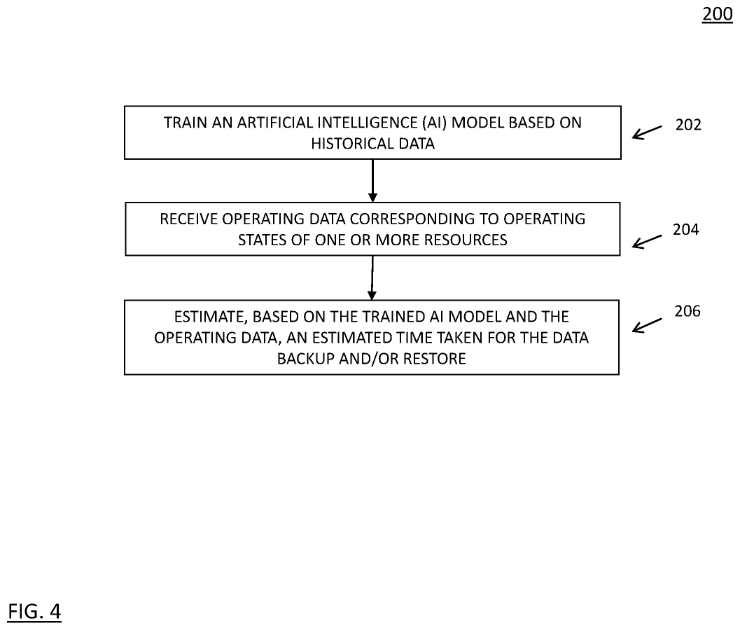

Referring again to FIG. 3, the data backup/restore scheduling system 130 further includes a memory 138 storing one or more processor-executable routines, and a processor 139. The processor 139 is further configured to execute the processor-executable routines to perform the steps illustrated in the flow-chart of FIG. 4.

FIG. 4 is a flowchart illustrating a method 200 to optimize scheduling of a data backup and/or restore of backup data in a data backup/restore environment. The method 200 may be implemented using the data backup/restore scheduling system 130 of FIG. 3 according to some aspects of the present description. Each step of the method 200 is described in detail below.

The method 200 includes, at block 202, training an artificial intelligence (AI) model based on historical data corresponding to data backup and/or restore of one or more training datasets. Non-limiting examples of the AI model include time series forecasting models such as an autoregressive integrated moving average (ARIMA) model or a seasonal autoregressive integrated moving average (SARIMA) model.

The one or more training data sets may correspond to data from the same or a different client device as the one being currently backed up/restored. Further, in some instances, the one or more training data sets may correspond to data from a different client. Moreover, the historical data corresponding to the one or more training data sets may correspond to an incremental backup or a full backup.

Non-limiting examples of historical data used to train the AI model include client device parameters, proxy parameters, file system parameters, data backup system parameters, data backup server parameters, network parameters, parallelization parameters, dataset type, dataset size, day of the week, time of the day, and time taken for data backup and/or restore for the training datasets.

Client device parameters may include, for example, CPU, IO bandwidth, network bandwidth, memory device IOs, Device NW throughput, and the like. Proxy parameters may include, for example, number of proxies, proxy CPUs, proxy memory, proxy NW bandwidth and the like. File system parameters may include, for example, Read FS minimum concurrency, maximum percentage memory, data channel size, and the like. Data backup system parameters may include, for example, internal back up systems' performance on read, write, merge, concurrency, channel size, etc. Data backup server parameters may include, for example, AWS parameters such as instance type, instance size, availability zone, etc.

Network parameters may include, for example, network requests, number of read APIs for each session, number of write APIs for each session, and the like. Parallelization parameters may include, for example, number of parallel backups, number of parallel restores, and the like. The historical data may further include metadata such as type of operation (backup/restore), operation status (success/failure), dataset type, dataset size, day of the week, time of the day, and time taken for data backup and/or restore.

At block 204, the method 200 includes receiving operating data corresponding to operating states of one or more resources in the data backup/restore environment. The operating data may be generated in real-time and/or based on a pre-defined configuration. For example, the number of proxies may be based on a pre-determined configuration while the network bandwidth may be recorded in real-time. The real-time operating data may be recorded using any suitable techniques, for example, open telemetry.

The method 200, further includes, at block 206, estimating, based on the trained AI model and the operating data, an estimated time taken for the data backup and/or restore of the backup data to a data backup server or a restore location. In some embodiments, the estimated time may be presented as an output to a user via any suitable output module. In some embodiments, the method 200 may further include periodically or continuously retraining the AI model based on the estimated time and actual time taken for a data backup and/or restore.

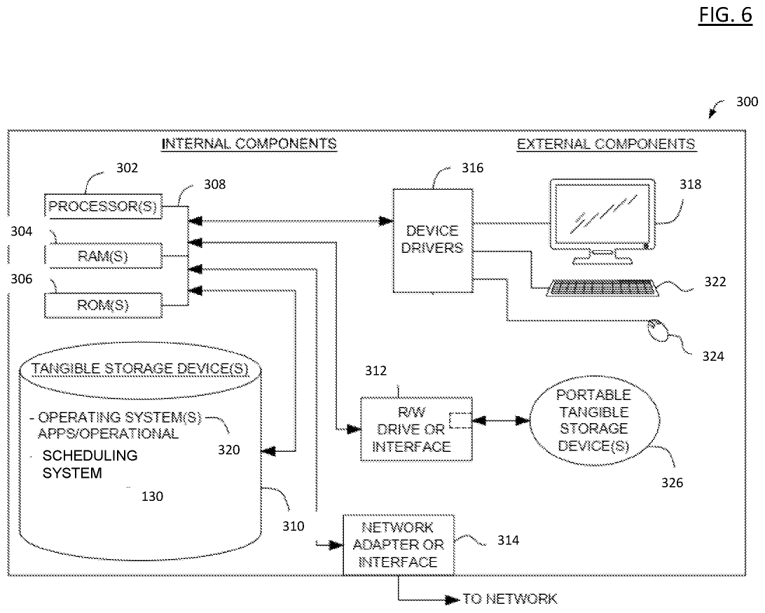

The time estimated for data backup/restore may be further used to generate an optimize schedule for data backup/restore in accordance with some embodiments of the present description. Referring now to FIG. 6, the method 200 further includes, at block 208, receiving periodic operating data corresponding to resource utilization for data backup and/or restore in the data backup and/or restore environment. At block 210, the method 200 include generating a historical resource utilization schedule based on the periodic operating data. The method 200 further includes, at block 212, storing the resource utilization schedule in a resource utilization database. At block 214, the method 200 further includes generating and recommending an optimized schedule for the data backup and/or restore of the backup data based on the estimated time and a historical resource utilization schedule.

In some embodiments, the recommended schedule may be presented as output to a user via a suitable output module. The output can be presented to user in multiple ways, such as, for example, GUI, API, integration to event management systems, messaging/alerting systems, ticket management systems, virtualization platforms, etc. The recommended schedule may include details such as a recommended date and time for data backup/restore.

The recommended schedule may be further used to estimate a cost for data backup/restore in accordance with some embodiments of the present description. In such instances, the method 200 may further include estimating a resource usage based on the recommended schedule or a schedule selected by a user for the data backup and/or restore of the backup data; and estimating a cost for the data backup and/or restore of the backup data based on the estimated resource usage.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

One example of a computing system 300 is described below in FIG. 6. The computing system 300 includes one or more processor 302, one or more computer-readable RAMs 304 and one or more computer-readable ROMs 306 on one or more buses 308. Further, the computer system 308 includes a tangible storage device 310 that may be used to execute operating systems 320 and the data backup/restore scheduling system 130. Both, the operating system 320 and data backup/restore scheduling system 130 are executed by processor 302 via one or more respective RAMs 304 (which typically includes cache memory). The execution of the operating system 320 and/or the data backup/restore scheduling system 130 by the processor 302, configures the processor 302 as a special-purpose processor configured to carry out the functionalities of the operation system 320 and/or the data backup/restore scheduling system 130, as described above.

Examples of storage devices 310 include semiconductor storage devices such as ROM 506, EPROM, flash memory or any other computer-readable tangible storage device that may store a computer program and digital information.

Computer system 300 also includes a R/W drive or interface 312 to read from and write to one or more portable computer-readable tangible storage devices 326 such as a CD-ROM, DVD, memory stick or semiconductor storage device. Further, network adapters or interfaces 314 such as a TCP/IP adapter cards, wireless Wi-Fi interface cards, or 3G or 4G wireless interface cards or other wired or wireless communication links are also included in the computer system 300.

In one example embodiment, the data backup/restore scheduling system 130 may be stored in tangible storage device 310 and may be downloaded from an external computer via a network (for example, the Internet, a local area network or another wide area network) and network adapter or interface 314.

Computer system 300 further includes device drivers 316 to interface with input and output devices. The input and output devices may include a computer display monitor 318, a keyboard 322, a keypad, a touch screen, a computer mouse 324, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system to optimize scheduling of a data backup and/or restore of a backup data in a data backup/restore environment, the system comprising:
a training module configured to train an artificial intelligence (AI) model based on historical data corresponding to data backup and/or restore of one or more training datasets; and
a time estimator configured to estimate an estimated time taken for the data backup and/or restore of the backup data to a data backup server or a restore location based on the trained AI model and operating data corresponding to operating states of one or more resources in the data backup/restore environment.

2. The system of claim 1, further comprising a scheduler configured to generate and recommend an optimized schedule for the data backup and/or restore based on the estimated time and a historical resource utilization schedule.

3. The system of claim 2, further comprising a resource utilization schedule generator configured to:
receive periodic operating data corresponding to resource utilization for data backup and/or restore in the data backup and/or restore environment;
generate the historical resource utilization schedule based on the periodic operating data; and
store the resource utilization schedule in a resource utilization database.

4. The system of claim 2, further comprising:
a resource usage estimator configured to estimate a resource usage based on the recommended schedule or a schedule selected by a user for the data backup and/or restore of the backup data; and
a cost estimator configured to estimate a cost for the data backup and/or restore of the backup data based on the estimated resource usage.

5. The system of claim 1, wherein the training module is further configured to periodically or continuously retrain the AI model based on the estimated time and actual time taken for a data backup and/or restore.

6. The system of claim 1, wherein the historical data comprises client device parameters, proxy parameters, file system parameters, data backup system parameters, data backup server parameters, network parameters, parallelization parameters, dataset type, dataset size, day of the week, time of the day, and time taken for data backup and/or restore for the training datasets.

7. The system of claim 1, wherein the operating data is generated in real-time and/or based on a pre-defined configuration.

8. A system to optimize scheduling of a data backup and/or restore of a backup data in a data backup and/or restore environment, the system comprising:
a memory storing one or more processor-executable routines; and
a processor communicatively coupled to the memory, the processor configured to execute the one or more processor-executable routines to:
train an artificial intelligence (AI) model based on historical data corresponding to data backup and/or restore of one or more training datasets;
receive operating data corresponding to operating states of one or more resources in the data backup and/or restore environment; and
estimate based on the trained AI model and the operating data an estimated time taken for the data backup and/or restore of the backup data to a data backup server or a restore location.

9. The system of claim 8, wherein the processor is further configured to execute the one or more processor-executable routines to generate and recommend an optimized schedule for the data backup and/or restore of the backup data based on the estimated time and a historical resource utilization schedule.

10. The system of claim 9, wherein the processor is further configured to execute the one or more processor-executable routines to:
receive periodic operating data corresponding to resource utilization for data backup and/or restore in the data backup and/or restore environment;
generate the historical resource utilization schedule based on the periodic operating data; and
store the resource utilization schedule in a resource utilization database.

11. The system of claim 9, wherein the processor is further configured to execute the one or more processor-executable routines to:
estimate a resource usage based on the recommended schedule or a schedule selected by a user for the data backup and/or restore of the backup data; and
estimate a cost for the data backup and/or restore of the backup data based on the estimated resource usage.

12. The system of claim 8, wherein the processor is further configured to execute the one or more processor-executable routines to periodically or continuously retrain the AI model based on the estimated time and actual time taken for a data backup and/or restore.

13. The system of claim 8, wherein the historical data comprises client device parameters, proxy parameters, file system parameters, data backup system parameters, data backup server parameters, network parameters, parallelization parameters, dataset type, dataset size, day of the week, time of the day, and time taken for data backup and/or restore for the training datasets.

14. A method to optimize scheduling of a data backup and/or restore of backup data in a data backup/restore environment, the method comprising:
training an artificial intelligence (AI) model based on historical data corresponding to data backup and/or restore of one or more training datasets;
receiving operating data corresponding to operating states of one or more resources in the data backup/restore environment; and
estimating, based on the trained AI model and the operating data, an estimated time taken for the data backup and/or restore of the backup data to a data backup server or a restore location.

15. The method of claim 14, further comprising generating and recommending an optimized schedule for the data backup and/or restore of the backup data based on the estimated time and a historical resource utilization schedule.

16. The method of claim 15, further comprising:
receiving periodic operating data corresponding to resource utilization for data backup and/or restore in the data backup and/or restore environment;
generating the historical resource utilization schedule based on the periodic operating data; and
storing the resource utilization schedule in a resource utilization database.

17. The method of claim 15, further comprising:
estimating a resource usage based on the recommended schedule or a schedule selected by a user for the data backup and/or restore of the backup data; and
estimating a cost for the data backup and/or restore of the backup data based on the estimated resource usage.

18. The method of claim 14, further comprising periodically or continuously retraining the AI model based on the estimated time and actual time taken for a data backup and/or restore.

19. The method of claim 14, wherein the historical data comprises client device parameters, proxy parameters, file system parameters, data backup system parameters, data backup server parameters, network parameters, parallelization parameters, dataset type, dataset size, day of the week, time of the day, and time taken for data backup and/or restore for the training datasets.

20. The method of claim 14, wherein the operating data is generated in real-time and/or based on a pre-defined configuration.
